(19) United States
(12) Patent Application Publication
(10) Pub. No.: US 2026/0094462 A1
(43) Pub. Date: Apr. 2, 2026

(54) Devices and Methods Utilizing Spatial Computing and Machine Learning to Locate and Decode a Label

(71) Applicant: Zebra Technologies Corporation, Lincolnshire, IL (US)

(72) Inventors: Andrew R. Calvarese, Stony Brook, NY (US); Richard Mark Clayton, Manorville, NY (US); Paul Seiter, Port Jefferson Station, NY (US); Jason M. Gang, Plainview, NY (US)

(21) Appl. No.: 18/902,177

(22) Filed: Sep. 30, 2024

(51) Int. Cl. G06V 30/19; G06K 7/14; G06V 30/30

(52) U.S. Cl. CPC G06V 30/191; G06V 30/30; G06K 7/1413

(57) ABSTRACT

Devices and methods for locating and decoding a label are disclosed herein. The method receives, by a device, information of an area, and captures, by the device, a first image of one or more objects within the area. The method derives a first location and a first orientation of the device during capture of the first image based on the information and first data of at least one sensor of the device. The method detects a first label associated with a first object and processes the first label. The method determines a location of the first label associated with the first object within the area based on the derived first location and first orientation of the device, and assigns the first label a first indicator denoting the determined location of the first label and that the first label has been processed.

### BACKGROUND

Logistics operations include the transportation and delivery of objects (e.g., parcels, packages and the like) to specified destinations. Typically, objects are loaded into a container and transported by a vehicle having the container affixed thereto or integrated therein for delivery to respective destinations. The objects are retrieved from the container and deposited at the respective destinations, such as residences or businesses. The retrieval of the objects from the container for delivery may be time-consuming, reducing the efficiency of the delivery process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating a system for the transportation and delivery of objects.

FIG. 2 is a diagram illustrating components of the computing device of FIG. 1.

FIGS. 3A-B are flowcharts illustrating processing steps carried out by an embodiment of the present disclosure.

FIGS. 4A-B are diagrams illustrating the container of FIG. 1.

FIG. 5 is a diagram illustrating image capture carried out by an embodiment of the present disclosure.

FIGS. 6A-B are diagrams illustrating labels of an embodiment of the present disclosure.

FIG. 7 is a flowchart illustrating step 310 of FIG. 3A and step 328 of FIG. 3B in greater detail.

FIGS. 8A-D are diagrams illustrating label processing and label indicator assignment carried out by an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, the retrieval of the objects from the container for delivery may be time-consuming, reducing the efficiency of the delivery process. Conventional systems and methods utilize static and/or manual processes to identify objects, load the objects into a container, and retrieve the objects from the container. These static and/or manual processes rely on human intervention and, as such, can be time-consuming, cost-prohibitive, and error-prone (e.g., subject to human error). For example, a worker (e.g., a loader) may utilize a device (e.g., a scanner) to manually scan a label of an object and load the object into a container based on a planogram indicative of a predetermined placement of the object within the container. However, a worker may misread or ignore the planogram when loading the object and/or the object may shift within the container during transportation. Accordingly, an object within a container may not correspond to a planogram such that it may be challenging to identify the object and/or a location thereof within a container. As such, it may be challenging, inefficient, and time-consuming for an operator (e.g., a driver) of a vehicle having the container affixed thereto or integrated therein to identify and locate an object within the container to retrieve the object from the container for delivery to a destination because a location of the object within the container does not correspond to the planogram. For example, a driver may be required to utilize a scanner to manually scan a label of an object to identify the object and/or a location thereof within a container which can be time-consuming. In another example, a driver may utilize a device having a camera to capture a continuous stream of images of a plurality of objects to detect and identify (e.g., recognize and/or decode) labels of the respective objects to identify the respective objects and/or locations thereof within a container. However, the volume of images and plurality of labels present in each image often results in the duplicative recognition and/or decoding of previously recognized and/or decoded labels which reduces a processing efficiency of the device and an efficiency of the delivery process.

As such, conventional systems suffer from a general lack of versatility because these systems cannot automatically and dynamically identify and locate objects within a container during different logistics operations (e.g., loading, delivery, and/or collection). For example, these systems cannot automatically and dynamically identify labels associated with one or more objects loaded into and/or retrieved from a container based on mapping of an interior of the container, real-time imaging of the one or more objects within the container, and/or processing of the labels associated with the one or more objects.

Overall, this lack of versatility causes conventional systems to provide underwhelming performance and reduce the efficiency and general timeliness of executing and completing logistics operations. Thus, it is an objective of the present disclosure to eliminate these and other problems with conventional systems and methods via systems and methods that can automatically and dynamically identify labels associated with one or more objects loaded into and/or retrieved from a container based on mapping of an interior of the container, real-time imaging of the one or more objects within the container, and/or processing of the labels associated with the one or more objects.

In accordance with the above, and with the disclosure herein, the present disclosure includes improvements in computer functionality or improvements to other technologies at least because the present disclosure describes that, e.g., logistics operational systems, and their related various components, may be improved or enhanced with the disclosed dynamic system features and methods that automatically and dynamically identify labels associated with one or more objects loaded into and/or retrieved from a container based on mapping of an interior of the container, real-time imaging of the one or more objects within the container, and/or processing of the labels associated with the one or more objects.

That is, the present disclosure describes improvements in the functioning of an imaging and/or image processing device and/or system and/or a locationing device and/or system and/or “any other technology or technical field” (e.g., the field of image processing and/or the field of locationing). For example, the disclosed dynamic system features and methods improve and enhance the identification and locationing of objects loaded into and/or retrieved from a container by introducing automatic and dynamic identification of labels associated with one or more objects loaded into and/or retrieved from a container based on mapping of an interior of the container, real-time imaging of the one or more objects within the container, and/or processing of the labels associated with the one or more objects to mitigate (if not eliminate) worker error and eliminate inefficiencies typically experienced over time by systems lacking such features and methods. This improves the state of the art at least because such previous systems are inefficient as they lack the ability to automatically and dynamically identify and process labels associated with objects loaded into and/or retrieved from a container in real-time.

In addition, the present disclosure applies various features and functionality, as described herein, with, or by use of, a particular machine, e.g., a processor, a device, and/or other hardware components as described herein. Moreover, the present disclosure includes specific features other than what is well-understood, routine, conventional activity in the field, or adding unconventional steps that demonstrate, in various embodiments, particular useful applications, e.g., processing protocols of a device for automatically and dynamically identifying labels associated with one or more objects loaded into and/or retrieved from a container based on mapping of an interior of the container, real-time imaging of the one or more objects within the container, and/or processing of the labels associated with the one or more objects.

Accordingly, it would be highly beneficial to develop a system and method that can automatically and dynamically identify labels associated with one or more objects loaded into and/or retrieved from a container based on mapping of an interior of the container, real-time imaging of the one or more objects within the container, and/or processing of the labels associated with the one or more objects. The systems and methods of the present disclosure address these and other needs.

In an embodiment, the present disclosure is directed to a method. The method comprises: receiving, by a device, information of an area where the information is indicative of a type of the area and a map of the area; capturing, by the device, a first image of one or more objects within the area; deriving a first location and a first orientation of the device during capture of the first image based on the information and first data of at least one sensor of the device; detecting a first label associated with a first object where the first label has one or more identifiers; processing the first label associated with the first object; determining a location of the first label associated with the first object within the area based on the derived first location and first orientation of the device; and assigning the first label a first indicator denoting the determined location of the first label and that the first label has been processed.

In an embodiment, the present disclosure is directed to a device comprising an imaging assembly; at least one sensor; one or more processors; and a non-transitory computer-readable memory coupled to the one or more processors. The memory stores instructions thereon that, when executed by the one or more processors, cause the one or more processors to: receive information of an area where the information is indicative of a type of the area and a map of the area; receive a first image, captured by the imaging assembly, of one or more objects within the area; derive a first location and a first orientation of the device during capture of the first image based on the information and first data of the at least one sensor; detect a first label associated with a first object where the first label has one or more identifiers; process the first label associated with the first object; determine a location of the first label associated with the first object within the area based on the derived first location and the first orientation of the device; and assign the first label a first indicator denoting the determined location of the first label and that the first label has been processed.

In an embodiment, the present disclosure is directed to a non-transitory computer-readable medium. The non-transitory computer-readable medium stores instructions thereon that, when executed by one or more processors, cause the one or more processors to: receive information of an area where the information is indicative of a type of the area and a map of the area; receive, from an imaging assembly, a first image of one or more objects within the area; derive a first location and a first orientation of the device during capture of the first image based on the information and first data of at least one sensor of the device; detect a first label associated with a first object where the first label has one or more identifiers; process the first label associated with the first object; determine a location of the first label associated with the first object within the area based on the derived first location and the first orientation of the device; and assign the first label a first indicator denoting the determined location of the first label and that the first label has been processed.

In an embodiment, the present disclosure is directed to a method. The method comprises: deriving a location and orientation of a device during capture of an image of one or more objects present in an area based on information of the area and data of at least one sensor of the device where the information is indicative of a type of the area and a map of the area; detecting a first label associated with a first object, the first label having one or more identifiers; processing the first label associated with the first object; determining a location of the first label associated with the first object within the area based on the derived location and orientation of the device; and assigning the first label an indicator denoting the determined location of the first label and that the first label has been processed.

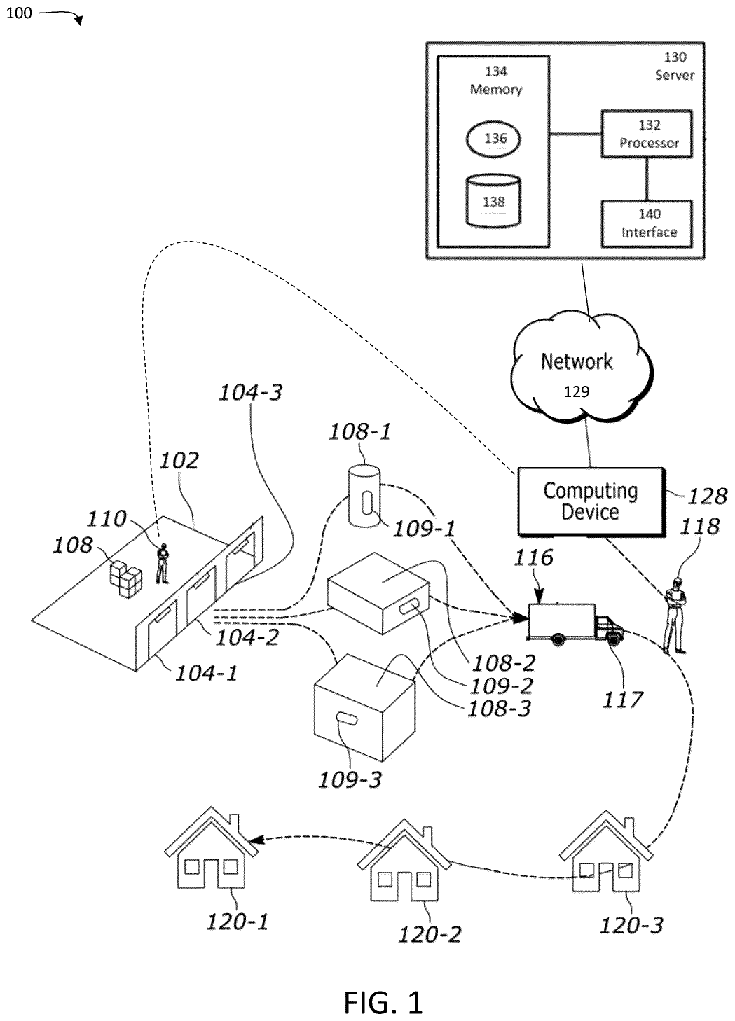

Turning to the Drawings, FIG. 1 is a diagram 100 illustrating an embodiment of the present disclosure. As shown in FIG. 1, an object handling facility 102 (e.g., a warehouse, manufacturing facility, retail facility, and transit facility such as an airport, depot, or the like) can have load bays 104-1, 104-2, and 104-3 (collectively referred to as load bays 104, and generically referred to as a load bay 104). The facility 102 can include a portion of a building, such as a cross dock or portion thereof, including the load bays 104.

The load bays 104 may, for example, be arranged along an outer wall of the facility 102, such that one or more containers 116 can be positioned proximate to the load bays 104 from the exterior of the facility 102. In other examples, smaller or greater numbers of load bays 104 may be included. The load bays 104 are illustrated as being dock structures enabling access from within the facility 102 to an exterior of the facility 102 where a container 116 is positioned. In other examples, one or more of the load bays 104 may be implemented as a load station within the facility 102, to load or unload containers 116 that are handled inside the facility 102.

Each load bay 104 may be configured to accommodate a container 116 such that one or more containers 116 can be positioned proximate to the load bays 104 from the exterior of the facility 102. The container 116 can be implemented as, but is not limited to, a storage unit affixed to or stored in a vehicle 117 such as a box portion of a box truck in which the box is affixed to a body of a vehicle which also supports a cab, powertrain, and the like, a semi-trailer including an enclosed box (e.g., trailer) affixed to a platform including one or more sets of wheels and a hitch assembly for towing by a powered vehicle, and a unit loading device (ULD) of the type employed to load luggage, freight and the like into aircraft. The container 116 can also be implemented as, but is not limited to, a storage area integrated in at least a portion of a vehicle 117 including a van (e.g., a cargo van, a commercial van, a sprinter van, or a step van) and a sports utility vehicle (SUV). The container 116 may have a substantially horizontal internal depth, extending from an open end (e.g., a wall with a door or other opening allowing access to an interior of the container 116) of the container 116 to a closed end, a substantially horizontal internal width perpendicular to the depth, and a substantially vertical internal height. It should be understood that the container 116 can also be implemented as a generic storage area having finite dimensions for storing one or more objects such that the storage area need not be affixed to or stored in a vehicle 117 or integrated in at least a portion of a vehicle 117. For example, a generic storage area can include, but is not limited to, a locker, an office, a mail room, an inventory room, a garage, and an indoor storage unit.

Each load bay 104 includes an opening, e.g., in a wall of the facility 102, that allows a worker 110 (e.g., a loader) and/or equipment within the facility 102 to access an interior of the container 116. For example, when a container 116 is positioned at a load bay 104 (e.g., with the open end of the container 116 substantially flush with the opening of the load bay 104), objects 108-1, 108-2, and 108-3 (collectively referred to as the objects 108, and generically referred to as an object 108) can be loaded into the container 116 (e.g., from a staging area for unloaded objects 108) or unloaded from the container 116 for processing within the facility 102. In some examples, the facility 102 includes one or more conveyor belts or other object transport mechanisms (not shown) to transport and load objects 108 into the container 116 or unload objects 108 from the container 116 to other locations within the facility 102.

A worker 110 may manually scan a label of an object 108 where the label comprises one or more identifiers (e.g., a barcode, a numeric character string, an alpha character string, and an alphanumeric character string) and load the object 108 into a container 116 based on a planogram indicative of a predetermined placement of the object 108 within the container 116. However, a worker 110 may misread or ignore the planogram when loading the object 108 and/or the object 108 may shift within the container 116 during transportation. As such, it may be challenging and time-consuming for an operator 118 (e.g., driver) of a vehicle 117 having the container 116 affixed thereto or integrated therein to identify and locate an object 108 within the container 116 to retrieve the object 108 from the container 116 for delivery to a destination because a location of the object 108 within the container 116 does not correspond to the planogram. Additionally, a loader 110 and a driver 118 often work independently of one another, and therefore a driver 118 cannot recall a location of an object 108 within a container 116 from memory because the driver 118 did not load the object 108 into the container 116.

In logistics operations, a wide variety of objects, such as packages and other freight, can be transported from origin locations to destination locations, often via a variety of intermediate locations. As shown in FIG. 1, objects 108 may be transported from the facility 102 to destination locations, such as residences 120-1, 120-2, and 120-3 (collectively referred to as the destination locations 120, and generically referred to as a destination location 120) via a container 116 implemented as a storage unit affixed to or stored in a vehicle 117 (e.g., a box truck, a semi-trailer, or the like) or a container 116 implemented as a storage area integrated in at least a portion of a vehicle 117 such as a van (e.g., a cargo van, a commercial van, a sprinter van, or a step van) and an SUV. At each destination location 120, an operator 118 can retrieve the relevant object(s) 108 destined for that destination location 120, remove the relevant object(s) 108 from the container 116, and deliver the relevant object(s) 108 to the destination location 120 before proceeding to the next destination location 120. Additionally, objects 108 can be collected from these destination locations 120 and/or from other destination locations between deliveries. Each object 108 may have a respective label 109-1, 109-2, and 109-3 (collectively referred to as labels 109, and generically referred to as a label 109) to identify the object 108. A label 109 may include, but is not limited to, one or more identifiers (e.g., a barcode, a numeric character string, an alpha character string, and an alphanumeric character string). The number of objects 108, and the number of destination locations 120, can vary, and need not be equal in other examples (e.g., more than one object 108 can be delivered to a single destination location 120).

The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, or flash memory). The processor 132 and the memory 134 each comprise one or more integrated circuits.

The memory 134 stores computer readable instructions for execution by the processor 132. The memory 134 stores a locationing application 136 (also referred to simply as the application 136) which, when executed by the processor 132, configures the processor 132 to perform various functions described below in greater detail and related to automatically and dynamically identifying labels 109 associated with one or more objects 108 loaded into and/or retrieved from a container 116 based on mapping of an interior of the container 116, real-time imaging of the one or more objects 108 within the container 116, and/or processing of the labels 109 associated with the one or more objects 108. For example, the application 136, when executed by the processor 132, configures the processor 132 to: receive information of an area (e.g., a container 116) where the information is indicative of a type of the area and a map of the area; receive an image, captured by an imaging assembly (not shown) of a device 128, of one or more objects 108 within the area; derive a location and orientation of the device 128 during capture of the image based on the information and data of at least one sensor (not shown) of the device 128; detect a label 109 associated with an object 108 where the label 109 has one or more identifiers; process the label 109 associated with the object 108; determine a location of the label 109 associated with the object 108 within the area based on the derived location and orientation of the device 128; and assign the label 109 an indicator denoting the determined location of the label 109 and that the label 109 has been processed. As described below, this functionality can also be executed by the processor 202 of the device 102.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments.

The memory 134 also stores a database 138. The database 138 may store a planogram, a realogram, and associations between objects 108 and destination locations 120 including data defining a route that specifies a sequence in which the container 116 is to travel to the destination locations 120. A planogram is a layout description and/or illustration indicative of a predetermined placement of objects 108 within the container 116 and may be utilized by a worker 110 to place objects 108 in specified locations (e.g., a shelf number, a zone, or the like) within the container 116 while loading objects 108 into the container 116. A realogram is a layout description and/or illustration indicative of a real-time location of objects 108 within a container 116. The database 138 may store a variety of other data associated with the objects 108, such as sender identities and locations, object identifiers, object dimensions (e.g., one or more of width, length, and height), object weights, and the like. The database 138 may also store one or more image datasets of a plurality of labels 109 (e.g., for training a machine learning model to detect, classify and/or decode a label 109 and one or more identifiers thereof). The database 138 may also store one or more captured images where the images can be utilized to detect an object 108 based on the distinctive features (e.g., size, shape, color, or the like) thereof. It should be understood that the database 138 may be stored in a memory (not shown) of the computing device 128.

The server 130 also includes a communications interface 140 enabling the server 130 to communicate with other computing devices, including the device 128, via the network 129. The communications interface 140 includes suitable hardware elements (e.g. transceivers, ports and the like) and corresponding firmware according to the communications technology employed by the network 129.

As described in greater detail below, the system includes a device 128 associated with a worker 110, a container 116, a vehicle 117, and/or an operator 118. The device 128 may include, but is not limited to, a mobile computer, a heads-up display, a tablet, a smartphone, or a wearable computing device. The device 128 can be operated by a worker 110 and/or an operator 118 and includes at least an imaging assembly (e.g., a camera) having a field of view (FOV) and one or more sensors (e.g., an accelerometer, a gyroscope, a magnetometer, an altimeter, a proximity sensor or the like). Alternatively, the device 128 can be an imaging assembly having a FOV and one or more sensors integrated therein or coupled thereto.

The device 128 may capture an image or stream of images of an object 108 within a container 116. The device 128 can generate a record indicative of a location of a label 109 associated with an object 108 within the container 116. The device 128 can also generate and/or update a log (e.g., a manifest) associated with the container 116 based on a location of a label 109 where the log is indicative of an inventory of objects 108 within the container 116. The device 128 can exchange data with the server 130, e.g., via a network 128 implemented as any suitable combination of local and wide-area networks.

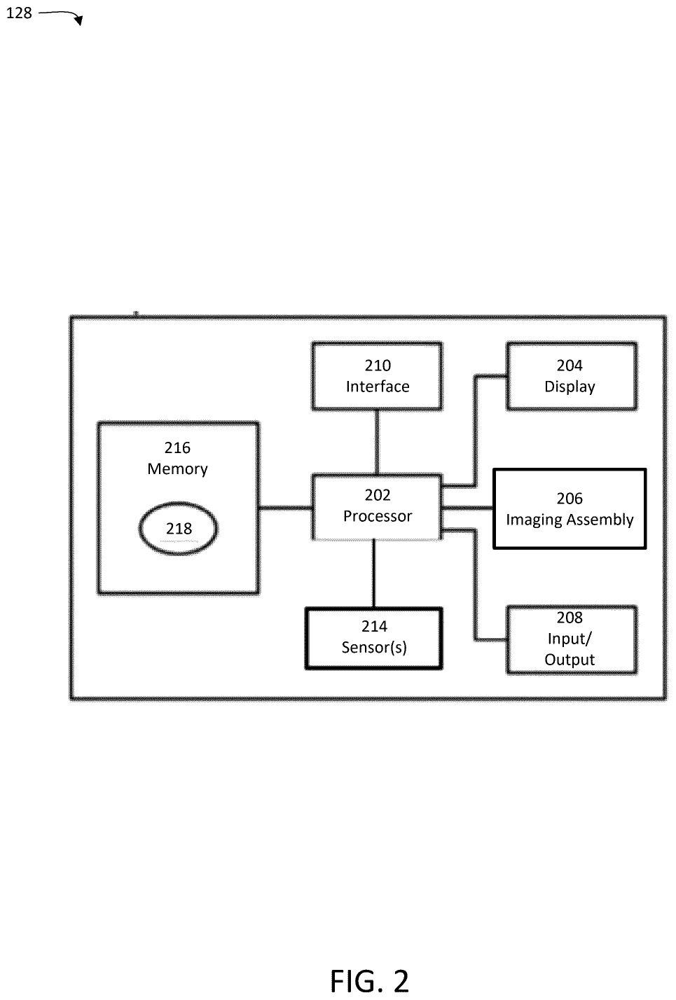

FIG. 2 is a diagram 200 illustrating components of the computing device 128 of FIG. 1. As illustrated in FIG. 2, the device 128 includes a processor 202, a display 204, an imaging assembly 206, an input/output 208, an interface 210, and a memory 216.

The processor 202 may be one or more CPUs, a graphics processing unit (GPU), or a combination thereof and is communicatively coupled with a display 204, an imaging assembly 206, an input 208, an interface 210, and a memory 216 (e.g., a non-transitory computer-readable storage medium implemented as a suitable combination of volatile and non-volatile memory elements). The memory 216 includes a combination of volatile memory (e.g. Random Access Memory or RAM) and non-volatile memory (e.g. read only memory or ROM, Electrically Erasable Programmable Read Only Memory or EEPROM, or flash memory). The processor 202 and the memory 204 each comprise one or more integrated circuits.

The memory 216 can store a plurality of computer-readable instructions, e.g., in the form of a locationing application 218 (also referred to simply as the application 218) which, when executed by the processor 202, configures the processor 202 to perform various functions described below in greater detail and related to automatically and dynamically identifying labels 109 associated with one or more objects 108 loaded into and/or retrieved from a container 116 based on mapping of an interior of the container 116, real-time imaging of the one or more objects 108 within the container 116, and/or processing of the labels 109 associated with the one or more objects 108. For example, the application 218, when executed by the processor 202, configures the processor 202 to: receive information of an area (e.g., a container 116) where the information is indicative of a type of the area and a map of the area; receive an image, captured by an imaging assembly 206 of a device 128, of one or more objects 108 within the area; derive a location and orientation of the device 128 during capture of the image based on the information and data of at least one sensor 214 of the device 128; detect a label 109 associated with an object 108 where the label 109 has one or more identifiers; process the label 109 associated with the object 108; determine a location of the processed label 109 associated with the object 108 within the area based on the derived location and orientation of the device 128; and assign the label 109 an indicator denoting the determined location of the label 109 and that the label 109 has been processed.

The application 218 may also be implemented as a suite of distinct applications in other examples. Those skilled in the art will appreciate that the functionality implemented by the processor 202 via the execution of the application 218 may also be implemented by one or more specially designed hardware and firmware components, such as FPGAs, ASICs, and the like in other embodiments. As noted above, in some examples the memory 216 can also store the database 138, rather than the database 138 being stored at the server 130.

The display 204 may be any suitable display including, but not limited to, a light emitting diode (LED) display, an organic LED display, a liquid crystal display (LCD), and a touchscreen display.

The imaging assembly 206 (e.g., a camera) may include a suitable sensor (e.g., an accelerometer, a gyroscope, a magnetometer, an altimeter, or a proximity sensor) or combination of sensors. Alternatively, the imaging assembly 206 and the sensor(s) 214 may be independent of one another. In another alternative, the device 128 may be an imaging assembly 206 (e.g., a camera) having a FOV and one or more sensors 214 integrated therein or coupled thereto.

The input 208 can be a device interconnected with the processor 202. The input device 208 is configured to receive an input (e.g. from a user of the device 128) and provide data representative of the received input to the processor 202. The input device 206 can include any one of, or a suitable combination of, a touch screen integrated with the display 204, a keypad, a microphone, and the like. In addition to the display 204, the device 128 can also include an output 208. The output 208 can be a device interconnected with the processor 202. The output device 208 is configured to receive an output (e.g., a signal from a processor 202) and provide an indication representative of the received output. The output device 206 can include any one of, or a suitable combination of a speaker, a headset, a notification LED, and the like.

The communications interface 210 enables communication between the device 128 and other computing devices (e.g., a server 130), via suitable short-range links, networks such as the network 129, and the like. The interface 210 therefore includes suitable hardware elements, executing suitable software and/or firmware, to communicate over the network 129 and/or other communication links.

The sensor(s) 214 can include any one of, or any suitable combination of, sensors configured to facilitate tracking a location of a device 128 within a container 116. For example, the sensor(s) 214 can comprise an inertial navigation system including one or more of an accelerometer, a gyroscope, a magnetometer, an altimeter, or a proximity sensor. In this way, the sensor(s) 214 in conjunction with one or more other components (e.g., the imaging assembly 206) of the device 128 provide for spatial computing to track a position and orientation of a user (e.g., an operator 118) utilizing the device 128.

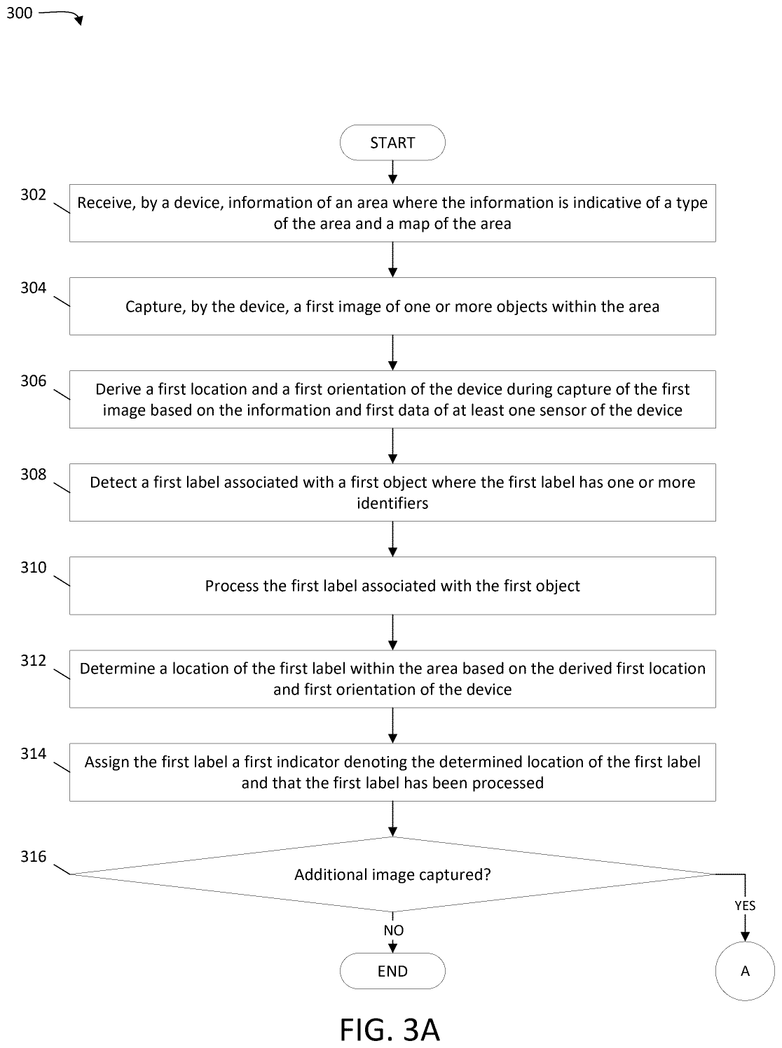

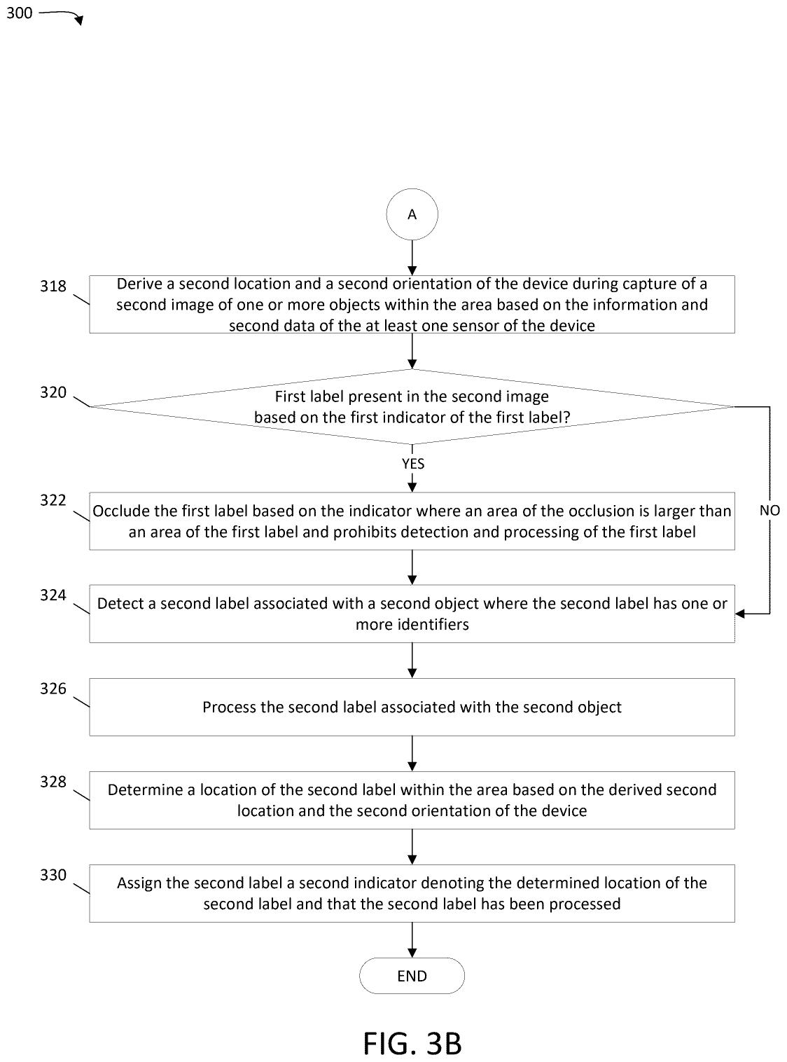

FIGS. 3A-B are flowcharts illustrating processing steps carried out by an embodiment of the present disclosure. The processing steps will be described in conjunction with their performance in the system (e.g., by the device 128 or the server 130 in conjunction with the device 128). In general, via performance of the processing steps, the system can automatically and dynamically identify labels 109 associated with one or more objects 108 loaded into and/or retrieved from a container 116 based on mapping of an interior of the container 116, real-time imaging of the one or more objects 108 within the container 116, and/or processing of the labels 109 associated with the one or more objects 108.

For example, the system can receive, by a device, information of an area where the information is indicative of a type of the area and a map of the area; capture, by the device, a first image of one or more objects within the area; derive a first location and a first orientation of the device during capture of the first image based on the information and first data of at least one sensor of the device; detect a first label associated with a first object where the first label has one or more identifiers; process the first label associated with the first object; determine a location of the first label associated with the first object within the area based on the derived first location and first orientation of the device; and assign the first label a first indicator denoting the determined location of the first label and that the first label has been processed.

Referring to FIG. 3A, in step 302, the system receives, by a device 128, information of an area (e.g., a container 116) indicative of an interior of a container 116. The device 128 may include, but is not limited to, a mobile computer, a heads-up display, a tablet, a smartphone, or a wearable computing device. The information may be indicative of a type of a container 116 (e.g., a make, a model, a size, a shape, or the like) and a map of the container 116. Generally, a container 116 has standard dimensions and a set configuration to comply with industry standards and/or federal regulations. The map of a container 116 may be a cartesian coordinate system of the interior of the container 116. The information may be stored on the device 128 or received from another computing device by scanning an indicium (e.g., a quick response (QR) code or other marker) associated with a container 116. As noted above, the device 128 can include sensor(s) 214 where the sensor(s) 214 can comprise an inertial navigation system including one or more of an accelerometer, a gyroscope, a magnetometer, an altimeter, or a proximity sensor configured to facilitate tracking a location of a device 128 within a container 116. Receiving the information by the device 128, calibrates the device 128 to the container 116 by deriving an initial location of the device 128 within the container 116 based on the information and initial data from the sensor(s) 214. As described in further detail below, the sensor(s) 214 in conjunction with one or more other components (e.g., the imaging assembly 206) of the device 128 provide for spatial computing (e.g., ARCore by Google) to track a position and orientation of a user (e.g., an operator 118) utilizing the device 128.

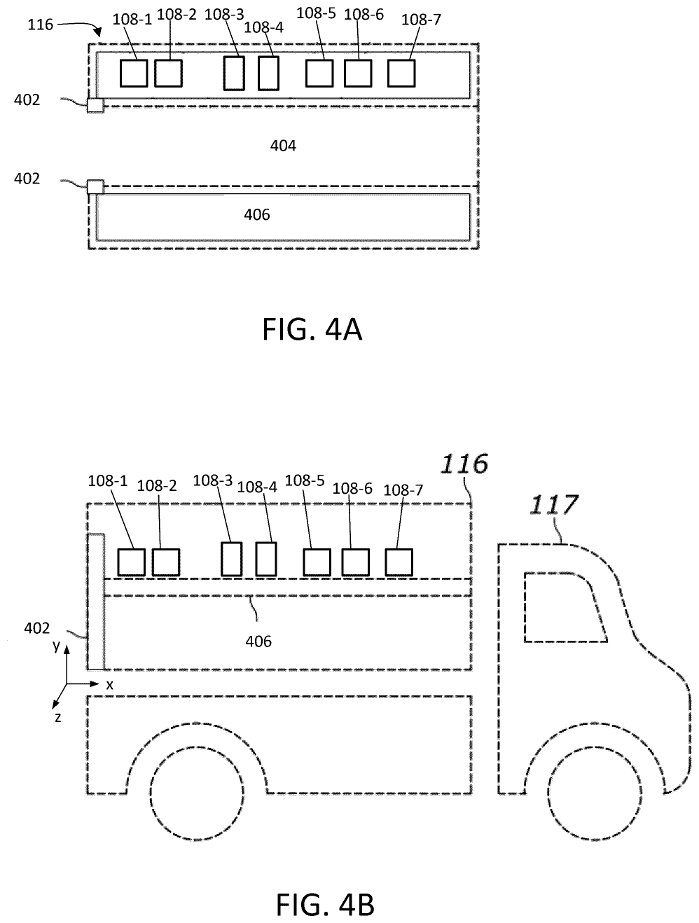

FIGS. 4A-B are diagrams illustrating the container 116 of FIG. 1. FIG. 4A is a diagram illustrating an overhead view of the container 116 of FIG. 1 and FIG. 4B is a diagram illustrating a side view of the container 116 of FIG. 1. As shown in FIGS. 4A and 4B, the container 116 is a storage unit affixed to a vehicle 117 (e.g., a box truck). In alternate embodiments, the container 116 may be one of a storage unit affixed to or stored in a vehicle 117 including a trailer affixed to a platform having one or more sets of wheels and a hitch assembly for towing by the vehicle, or a unit loading device (ULD) stored in an aircraft, or a storage area integrated in at least a portion of a vehicle 116 including a sports utility vehicle (SUV), a van, a cargo van, a commercial van, a sprinter van, or a step van. The container 116 may include a doorway 402, an aisle 404, at least one support structure such as a shelf 406 (two shelves 406 at approximately the same height are shown), onto which objects 108 can be positioned. The indicium may be positioned on an exterior or interior of the doorway or on any suitable exterior or interior surface of the vehicle 117. As noted above, a map of a container 116 may be a cartesian coordinate system of the interior of the container 116. As shown in FIGS. 4A and 4B, objects 108 are loaded into the container 116. As described in further detail below, the system may determine a location of a label 109 of an object 108 within the container 116 based on a derived first location and first orientation of the device 128 where the location of the label 109 may correspond to cartesian coordinates (e.g., an x-coordinate and a y-coordinate) of an interior of a container 116.

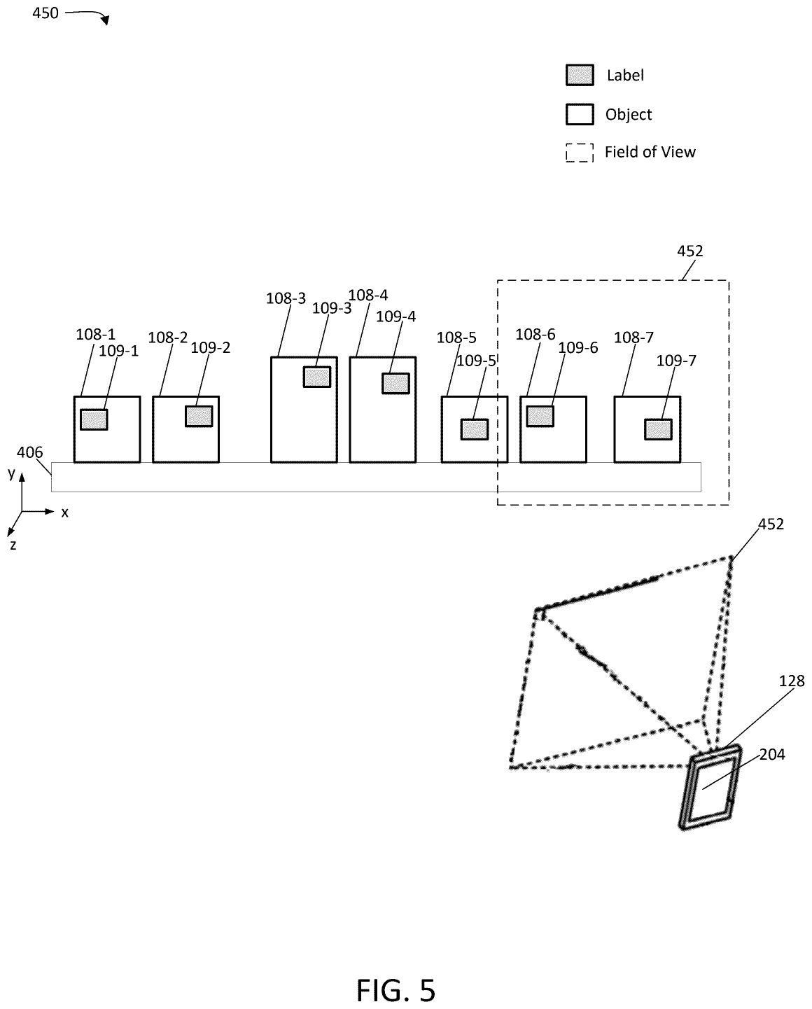

Referring back to FIG. 3A, in step 304, the system captures an image or a stream of images of one or more objects 108 positioned on a shelf 406 within the container 116 utilizing the device 128. FIG. 5 is a diagram 450 illustrating image capture carried out by an embodiment of the present disclosure. As shown in FIG. 5, the device 128 has a display 204 and an imaging assembly 206 (not shown) having a known FOV 452. The device 128 may capture an image or stream of images of one or more objects 108 within the FOV of the imaging assembly 206 such that the image or stream of images may include one or more objects 108 and respective labels 109 thereof. As shown in FIG. 5, a FOV 452 of the imaging assembly 206 (not shown) may capture an image or a stream of images including object 108-6 having a label 109-6 and object 108-7 having a label 109-7. As described in further detail below, the system can determine a location of a label 109 of an object 108 within a container 116 based, in part, by utilizing spatial computing to track a position and orientation of a user (e.g., an operator 118) utilizing the device 128 during image capture.

Referring back to FIG. 3A, in step 306, the system derives a location and orientation of the device 128 during capture of the image based on the information and data of at least one sensor 214 of the device 128. For example, the system may derive a spatial location and orientation of the device 128 within the container 116 during capture of the image based on a type of a container 116, a map of the container 116, and data from one or more of sensors 214 (e.g., an accelerometer, a gyroscope, a magnetometer, an altimeter, or a proximity sensor) of the device 128.

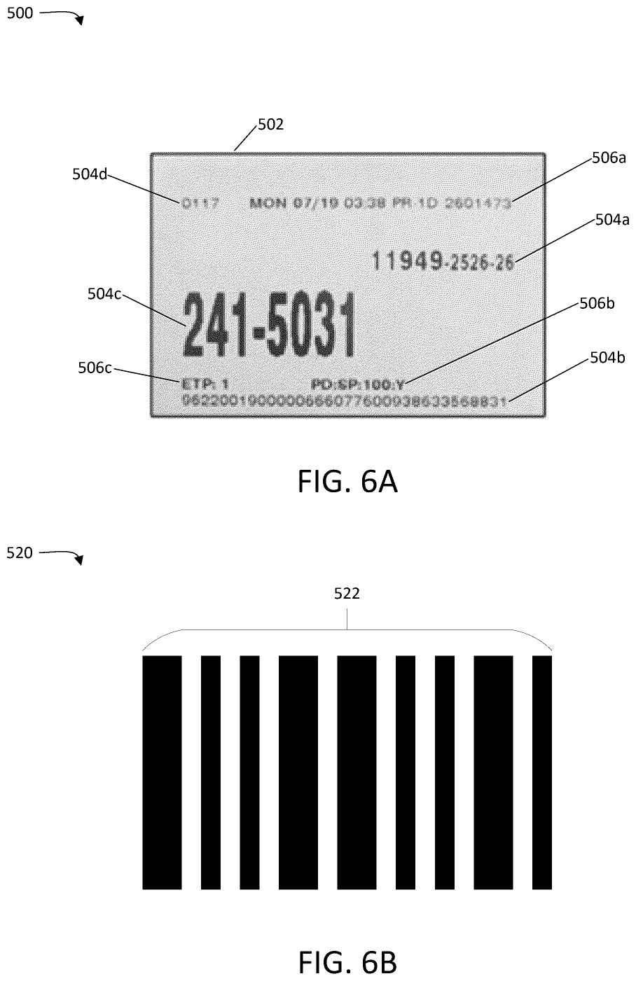

In step 308, the system detects a label 109 associated with an object 108. The label 109 can include one or more identifiers (e.g., a barcode, a numeric character string, an alpha character string, and an alphanumeric character string). FIGS. 6A-B are diagrams illustrating labels of an embodiment of the present disclosure. FIG. 6A is a diagram 500 illustrating a label 502 having numeric character strings 504a, 504b, 504c, and 504d and alphanumeric character strings 506a, 506b, and 506c. FIG. 6B is a diagram 520 illustrating a label 522. The label 552 is a barcode comprised of parallel lines have varying widths, spacings and sizes. As described in further detail below, the system can process a label 109 associated with an object 108.

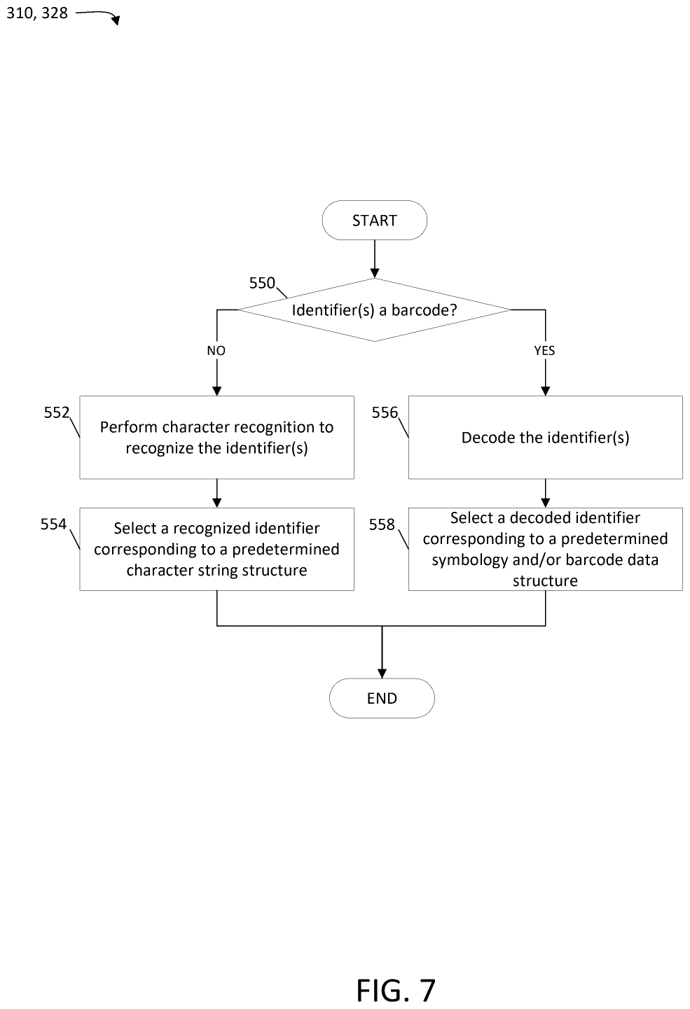

Referring back to FIG. 3A, the system processes a label 109 associated with an object 108. FIG. 7 is a flowchart illustrating step 310 of FIG. 3A in greater detail and step 328 of FIG. 3B in greater detail (as described below in reference to FIG. 3B). Beginning in step 550, the system determines whether one or more identifiers of a label 109 are indicative of a barcode. If the system determines the one or more identifiers of a label 109 are not indicative of a barcode, then the process proceeds to step 552. In step 552, the system utilizes character recognition to recognize the one or more identifiers. In an embodiment, the system may repeat step 552 to confirm the recognized the one or more identifiers. For example, the system may require that recognition of the one or more identifiers satisfy and/or exceed a predetermined confirmation threshold (e.g., an integer value). In this way, the system may prevent mis-recognizing the one or more identifiers. In step 554, the system selects a recognized identifier or, if the label 109 includes more than one identifier, the system selects a recognized identifier corresponding to a predetermined character string structure. Alternatively, if the system determines the one or more identifiers of a label 109 are indicative of a barcode, then the process proceeds to step 556. In step 556, the system decodes the one or more identifiers. Then, in step 558, the system selects a decoded identifier or, if the label 109 includes more than one identifier, the system selects a decoded identifier corresponding to a predetermined symbology (e.g., including, but not limited to, a Universal Product Code (UPC), European Article Number (EAN), Code 128, Code39, and Data Matrix) and/or barcode data structure.

Referring back to FIG. 3A, in step 312, the system determines a location of the label 109 within the container 116 based on the derived location and orientation of the device 128 during capture of the image. As noted above, the system derives a location and orientation of the device 128 based on the information (e.g., a map of a container 116) and data of at least one sensor 214 of the device 128. A map of a container 116 may be a cartesian coordinate system of the interior of the container 116. The system may determine cartesian coordinates (e.g., an x-coordinate and a y-coordinate) of a processed label 109 associated with an object 108 within a container 116 based on the derived location and orientation of the device 128.

In step 314, the system assigns the label 109 an indicator denoting the determined location (e.g., an x-coordinate and a y-coordinate) of the label 109 and that the label 109 has been processed. The indicator may be a flag or integer value (e.g., “1”). The system may generate a record indicative of a location of a label 109 associated with an object 108 within the container 116. The device 128 can also generate and/or update a log (e.g., a manifest) associated with the container 116 based on a location of a label 109 where the log is indicative of an inventory of objects 108 within the container 116. As described in further detail below in relation to FIG. 3B, the indicator prohibits the system from detecting and processing a label 109 if the label 109 is present in another or subsequent image. In this way, the system improves and enhances a processing efficiency of the device 128 and the identification and retrieval of an object 108 from a container 116 (e.g., an efficiency of a delivery process). Additionally, the system may transmit an indication indicative of a determined location of a label 109 associated with an object 108 to an operator 118 associated with a device 128 and/or a container 116. For example, the system may transmit a notification indicative of a determined location (e.g., an x-coordinate and a y-coordinate) of a label 109 associated with an object 108 to an operator 118 associated with a device 128 when proximate to a destination 120 associated with the label 109. In this way, the system provides for the rapid and efficient identification and retrieval of an object 108 from a container 116.

In step 316, the system determines whether another image (e.g., a second image) or a stream of images has been captured. If the system determines a second image or a stream of images has not been captured, then the process ends. Alternatively, if the system determines a second image or a stream of images has been captured, then the process proceeds to step 318 of FIG. 3B (as denoted by marker “A”).

As shown in FIG. 3B, in step 318, the system derives a location and orientation (e.g., a second location and a second orientation) of the device 128 during capture of the second image of one or more objects 108 within the container 116 based on the information and data (e.g., second data) of at least one sensor 214 of the device 128. For example, the system may derive a spatial location and orientation of the device 128 within the container 116 during capture of the second image based on a type of a container 116, a map of the container 116, and second data from one or more of sensors 214 (e.g., an accelerometer, a gyroscope, a magnetometer, an altimeter, or a proximity sensor) of the device 128.

In step 320, the system determines whether a previous label 109 (e.g., the label described in steps 308-314 of FIG. 3A) is present in the second image based on the indicator of the previous label 109. If the system determines the previous label 109 is present in the second image based on the indicator of the previous label 109, then the process proceeds to step 322. In step 322, the system occludes the previous label 109 based on the indicator. The occlusion may be larger than an area of the previous label 109 and prohibits detection and processing of the previous label 109. In an embodiment, the occlusion may be a shape (e.g., a square, a rectangle, or any suitable shape) that appears on a user interface (UI) displayed on a display 204 of the device 128. In this way, the system improves and enhances a processing efficiency of the device 128 by eliminating the duplicative detection and recognition and/or decoding of previously recognized and/or decoded labels 109, and improves and enhances the identification and retrieval of an object 108 from a container 116 (e.g., an efficiency of a delivery process). The process then proceeds to step 324. Alternatively, if the system determines the previous label 109 is not present in the second image based on the indicator of the previous label 109, then the process proceeds to step 324.

In step 324, the system detects a second label 109 associated with an object 108. The second label 109 can include one or more identifiers (e.g., a barcode, a numeric character string, an alpha character string, and an alphanumeric character string). The second label 109 is indicative of the previously described labels in relation to FIGS. 6A-B.

Referring back to FIG. 3B, in step 326, the system processes the second label 109 associated with an object 108. The processing of the second label 109 is indicative of the previously described processing steps in relation to FIG. 7.

Referring back to FIG. 3B, in step 328, the system determines a location of the second label 109 within the container 116 based on the derived second location and the second orientation of the device 128 during capture of the second image. As noted above, the system derives a location and orientation of the device 128 based on the information (e.g., a map of a container 116) and data of at least one sensor 214 of the device 128. A map of a container 116 may be a cartesian coordinate system of the interior of the container 116. The system may determine cartesian coordinates (e.g., an x-coordinate and a y-coordinate) of a second label 109 associated with an object 108 within a container 116 based on the derived second location and the second orientation of the device 128.

In step 330, the system assigns the second label 109 an indicator denoting the determined location (e.g., an x-coordinate and a y-coordinate) of the second label 109 and that the second label 109 has been processed. The indicator may be a flag or integer value (e.g., “1”). The system may generate a record indicative of a location of a second label 109 associated with an object 108 within the container 116. The device 128 can also generate and/or update a log (e.g., a manifest) associated with the container 116 based on a location of a second label 109 where the log is indicative of an inventory of objects 108 within the container 116. Additionally, the system may transmit an indication indicative of a determined location of a second label 109 associated with an object 108 to an operator 118 associated with a device 128 and/or a container 116. For example, the system may transmit a notification indicative of a determined location (e.g., an x-coordinate and a y-coordinate) of a second label 109 associated with an object 108 to an operator 118 associated with a device 128 when proximate to a destination 120 associated with the second label 109. In this way, the system provides for the rapid and efficient identification and retrieval of an object 108 from a container 116.

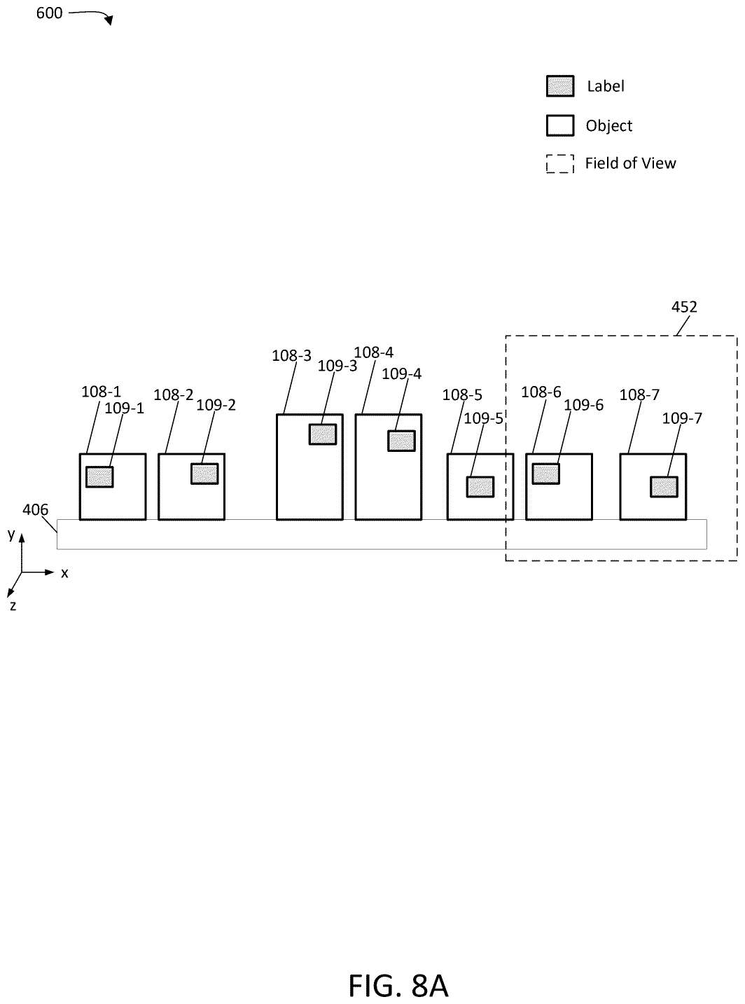

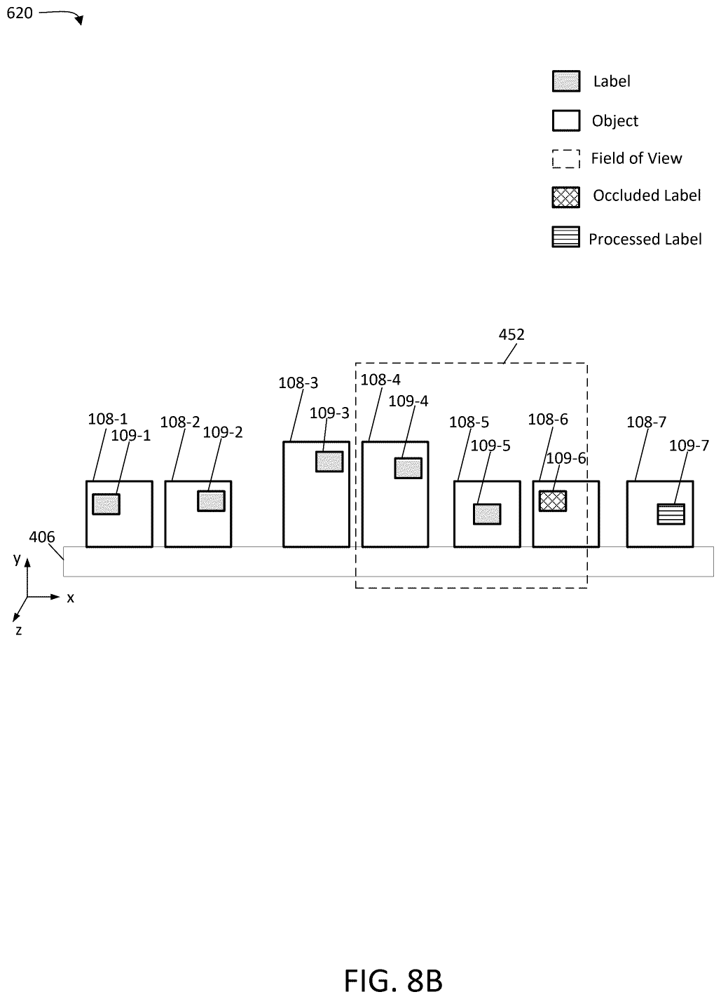

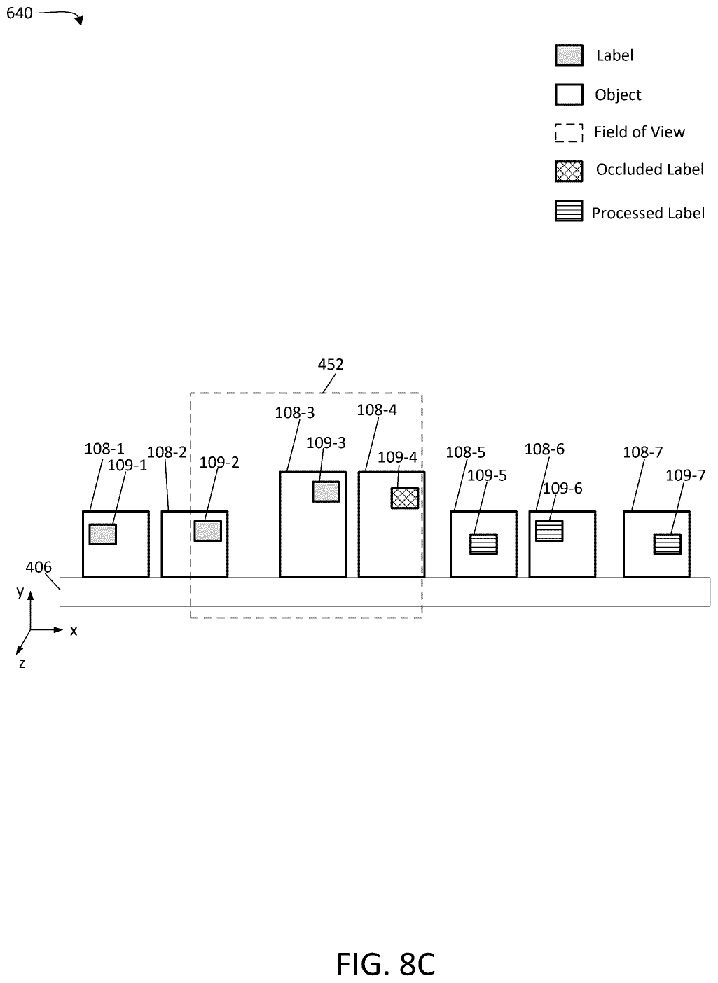

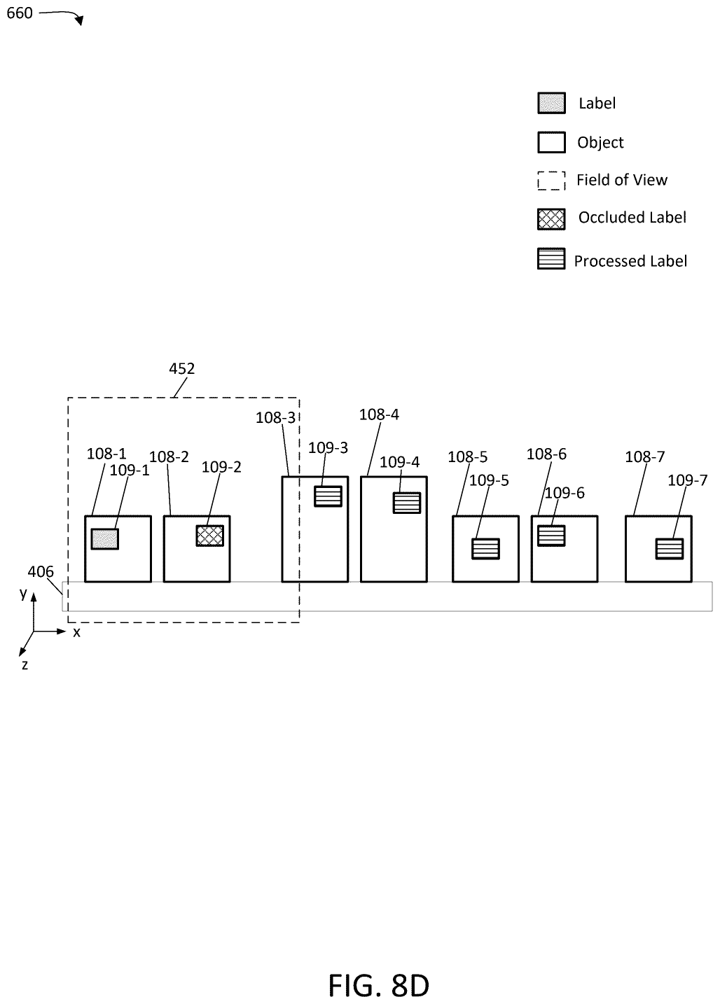

FIGS. 8A-D are diagrams 600, 620, 640, and 660 illustrating label processing and label indicator assignment carried out by an embodiment of the present disclosure. As shown in FIG. 8A, objects 108 (e.g., objects 108-1, 108-2, 108-3, 108-4, 108-5, 108-6, and 108-7) having respective labels 109 (e.g., labels 109-1, 109-2, 109-3, 109-4, 109-5, 109-6, and 109-7) are positioned on a shelf 406. Label 109-6 of object 108-6 and label 109-7 of object 108-7 are within a FOV 452 of an imaging assembly 206 (not shown) of a device 128 (also not shown). Accordingly, the system processes label 109-6 of object 108-6 and label 109-7 of object 108-7 as described above in relation to FIG. 7. The system also assigns label 109-6 an indicator denoting a determined location (e.g., an x-coordinate and a y-coordinate) of the label 109-6 within a container 116 and that the label 109-6 has been processed and assigns label 109-7 an indicator denoting a determined location (e.g., an x-coordinate and a y-coordinate) of the label 109-6 within the container 116 and that the label 109-6 has been processed.

As shown in FIG. 8B, label 109-4 of object 108-4, label 109-5 of object 108-5, and label 109-6 of object 108-6 are within a FOV 452 of the imaging assembly 206 (not shown) of the device 128 (also not shown). The system processes label 109-4 of object 108-4 and label 109-5 of object 108-5 as described above in relation to FIG. 7. The system also assigns label 109-4 an indicator denoting a determined location (e.g., an x-coordinate and a y-coordinate) of the label 109-4 within a container 116 and that the label 109-4 has been processed and assigns label 109-5 an indicator denoting a determined location (e.g., an x-coordinate and a y-coordinate) of the label 109-5 within the container 116 and that the label 109-5 has been processed. The system occludes label 109-6 based on the previously assigned indicator. The occlusion may be larger than an area of the previous label 109-6 and prohibits the system from detecting and processing the label 109-6. In an embodiment, the occlusion may be a shape (e.g., a square, a rectangle, or any suitable shape) that appears on a UI displayed on a display 204 of the device 128. In this way, the system improves and enhances a processing efficiency of the device 128 by eliminating the duplicative detection and recognition and/or decoding of previously recognized and/or decoded labels 109, and improves and enhances the identification and retrieval of an object 108 from a container 116 (e.g., an efficiency of a delivery process).

As shown in FIG. 8C, label 109-2 of object 108-2, label 109-3 of object 108-3, and label 109-4 of object 108-4 are within a FOV 452 of the imaging assembly 206 (not shown) of the device 128 (also not shown). The system processes label 109-2 of object 108-2 and label 109-3 of object 108-3 as described above in relation to FIG. 7. The system also assigns label 109-2 an indicator denoting a determined location (e.g., an x-coordinate and a y-coordinate) of the label 109-2 within a container 116 and that the label 109-2 has been processed and assigns label 109-3 an indicator denoting a determined location (e.g., an x-coordinate and a y-coordinate) of the label 109-3 within the container 116 and that the label 109-3 has been processed. The system occludes label 109-4 based on the previously assigned indicator. The occlusion may be larger than an area of the previous label 109-4 and prohibits the system from detecting and processing the label 109-4. In an embodiment, the occlusion may be a shape (e.g., a square, a rectangle, or any suitable shape) that appears on a UI displayed on a display 204 of the device 128. In this way, the system improves and enhances a processing efficiency of the device 128 by eliminating the duplicative detection and recognition and/or decoding of previously recognized and/or decoded labels 109, and improves and enhances the identification and retrieval of an object 108 from a container 116 (e.g., an efficiency of a delivery process).

As shown in FIG. 8D, label 109-1 of object 108-1 and label 109-2 of object 108-2 are within a FOV 452 of the imaging assembly 206 (not shown) of the device 128 (also not shown). The system processes label 109-1 of object 108-1 as described above in relation to FIG. 7. The system also assigns label 109-1 an indicator denoting a determined location (e.g., an x-coordinate and a y-coordinate) of the label 109-1 within a container 116 and that the label 109-1 has been processed. The system occludes label 109-2 based on the previously assigned indicator. The occlusion may be larger than an area of the previous label 109-2 and prohibits the system from detecting and processing the label 109-2. In an embodiment, the occlusion may be a shape (e.g., a square, a rectangle, or any suitable shape) that appears on a UI displayed on a display 204 of the device 128. In this way, the system improves and enhances a processing efficiency of the device 128 by eliminating the duplicative detection and recognition and/or decoding of previously recognized and/or decoded labels 109, and improves and enhances the identification and retrieval of an object 108 from a container 116 (e.g., an efficiency of a delivery process).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
receiving, by a device, information of an area, the information being indicative of a type of the area and a map of the area;
capturing, by the device, a first image of one or more objects within the area;
deriving a first location and a first orientation of the device during capture of the first image based on the information and first data of at least one sensor of the device;
detecting a first label associated with a first object, the first label having one or more identifiers;
processing the first label associated with the first object;
determining a location of the first label associated with the first object within the area based on the derived first location and first orientation of the device; and
assigning the first label a first indicator denoting the determined location of the first label and that the first label has been processed.

2. The method of claim 1, further comprising:
deriving a second location and a second orientation of the device during capture of a second image of one or more objects within the area based on the information and second data of the at least one sensor of the device;
determining the first label is present in the second image based on the first indicator of the first label; and
occluding, based on the first indicator, the first label, wherein an area of the occlusion is larger than an area of the first label and prohibits detecting and processing the first label.

3. The method of claim 2, further comprising:
detecting a second label associated with a second object, the second label having one or more identifiers;
processing the second label associated with the second object;
determining a location of the second label associated with the second object within the area based on the derived second location and the second orientation of the device; and
assigning the second label a second indicator denoting the determined location of the second label and that the second label has been processed.

4. The method of claim 1, wherein receiving, by the device, information of the area calibrates the device to the area by deriving an initial location of the device within the area based on the information and initial data of the at least one sensor of the device.

5. The method of claim 1, wherein
the area is an interior of a container, and
the container is one of
a storage unit affixed to or stored in a vehicle including a box affixed to a box truck, a trailer affixed to a platform having one or more sets of wheels and a hitch assembly for towing by the vehicle, or a unit loading device (ULD) stored in an aircraft, or
a storage area integrated in at least a portion of a vehicle including a sports utility vehicle (SUV), a van, a cargo van, a commercial van, a sprinter van, or a step van.

6. The method of claim 1, wherein
the device is one of a mobile computer, a heads up display, a tablet, a smartphone, or a wearable computing device; and
the at least one sensor is one or more of an accelerometer, a gyroscope, a magnetometer, or a proximity sensor.

7. The method of claim 1, wherein processing the first label associated with the first object comprises:
determining whether the one or more identifiers are indicative of a barcode;
responsive to determining the one or more identifiers are indicative of a barcode, decoding the one or more identifiers; and
selecting a decoded identifier corresponding to a predetermined symbology and/or barcode data structure.

8. The method of claim 1, wherein processing the first label associated with the first object comprises:
determining whether the one or more identifiers are indicative of a barcode;
responsive to determining the one or more identifiers are not indicative of a barcode, utilizing character recognition to recognize the one or more identifiers; and
selecting a recognized identifier corresponding to a predetermined character string structure.

9. The method of claim 1, further comprising:
generating a record of the determined location of the first label; and
modifying an entry of a log associated with the area based on the determined location of the first label, the log being indicative of an inventory of the one or more objects within the area.

10. The method of claim 1, further comprising transmitting an indication indicative of the determined location of the first label to a user associated with the area.

11. A device, comprising:
an imaging assembly;
at least one sensor;
one or more processors; and
a non-transitory computer-readable memory coupled to the one or more processors, the memory storing instructions thereon that, when executed by the one or more processors, cause the one or more processors to:
receive information of an area, the information being indicative of a type of the area and a map of the area;
receive a first image, captured by the imaging assembly, of one or more objects within the area;
derive a first location and a first orientation of the device during capture of the first image based on the information and first data of the at least one sensor;
detect a first label associated with a first object, the first label having one or more identifiers;
process the first label associated with the first object;
determine a location of the first label associated with the first object within the area based on the derived first location and the first orientation of the device; and
assign the first label a first indicator denoting the determined location of the first label and that the first label has been processed.

12. The device of claim 11, wherein the instructions, when executed, further cause the one or more processors to:
receive a second image, captured by the imaging assembly, of one or more objects within the area;
derive a second location and a second orientation of the device during capture of the second image based on the information and second data of the at least one sensor of the device;
determine the first label is present in the second image based on the first indicator of the first label; and
occlude, based on the first indicator, the first label, wherein an area of the occlusion is larger than an area of the first label and prohibits detecting and processing the first label.

13. The device of claim 12, wherein the instructions, when executed, further cause the one or more processors to:
detect a second label associated with a second object, the second label having one or more identifiers;
process the second label associated with the second object;
determine a location of the second label associated with the second object within the area based on the derived second location and the second orientation of the device; and
assign the second label a second indicator denoting the determined location of the second label and that the second label has been processed.

14. The device of claim 11, wherein the instructions, when executed, further cause the one or more processors to calibrate the device to the area by deriving an initial location of the device within the area based on the information and initial data of the at least one sensor of the device.

15. The device of claim 11, wherein
the area is an interior of a container, and
the container is one of
a storage unit affixed to or stored in a vehicle including a box affixed to a box truck, a trailer affixed to a platform having one or more sets of wheels and a hitch assembly for towing by the vehicle, or a unit loading device (ULD) stored in an aircraft, or
a storage area integrated in at least a portion of a vehicle including a sports utility vehicle (SUV), a van, a cargo van, a commercial van, a sprinter van, or a step van.

16. The device of claim 11, wherein
the device is one of a mobile computer, a heads up display, a tablet, a smartphone, or a wearable computing device; and
the at least one sensor is one or more of an accelerometer, a gyroscope, a magnetometer, or a proximity sensor.

17. The device of claim 11, wherein the instructions, when executed, cause the one or more processors to process the first label associated with the first object by:
determining whether the one or more identifiers are indicative of a barcode;
responsive to determining the one or more identifiers are indicative of a barcode, decoding the one or more identifiers; and
selecting a decoded identifier corresponding to a predetermined symbology and/or barcode data structure.

18. The device of claim 11, wherein the instructions, when executed, cause the one or more processors to process the first label associated with the first object by:
determining whether the one or more identifiers are indicative of a barcode;
responsive to determining the one or more identifiers are not indicative of a barcode, utilizing character recognition to recognize the one or more identifiers; and
selecting a recognized identifier corresponding to a predetermined character string structure.

19. The device of claim 11, wherein the instructions, when executed, further cause the one or more processors to:
generate a record of the determined location of the first label; and
modify an entry of a log associated with the area based on the determined location of the first label, the log being indicative of an inventory of the one or more objects within the area.

20. The device of claim 11, wherein the instructions, when executed, further cause the one or more processors to transmit an indication indicative of the determined location of the first label to a user associated with the area.

21. A non-transitory computer-readable medium storing instructions thereon that, when executed by one or more processors, cause the one or more processors to:
receive information of an area, the information being indicative of a type of the area and a map of the area;
receive, from an imaging assembly, a first image of one or more objects within the area;
derive a first location and a first orientation of the device during capture of the first image based on the information and first data of at least one sensor of the device;
detect a first label associated with a first object, the first label having one or more identifiers;
process the first label associated with the first object;
determine a location of the first label associated with the first object within the area based on the derived first location and the first orientation of the device; and
assign the first label a first indicator denoting the determined location of the first label and that the first label has been processed.

22. The non-transitory computer-readable medium of claim 21, wherein the instructions, when executed, further cause the one or more processors to:
receive, from the imaging assembly, a second image of one or more objects within the area;
derive a second location and a second orientation of the device during capture of the second image based on the information and second data of the at least one sensor of the device;
determine the first label is present in the second image based on the first indicator of the first label; and
occlude, based on the first indicator, the first label, wherein an area of the occlusion is larger than an area of the first label and prohibits detecting and processing the first label.

23. The non-transitory computer-readable medium of claim 22, wherein the instructions, when executed, further cause the one or more processors to:
detect a second label associated with a second object, the second label having one or more identifiers;
process the second label associated with the second object;
determine a location of the second label associated with the second object within the area based on the derived second location and the second orientation of the device; and
assign the second label a second indicator denoting the determined location of the second label and that the second label has been processed.

24. The non-transitory computer-readable medium of claim 21, wherein the instructions, when executed, further cause the one or more processors to calibrate the device to the area by deriving an initial location of the device within the area based on the information and initial data of the at least one sensor of the device.

25. The non-transitory computer-readable medium of claim 21, wherein the instructions, when executed, cause the one or more processors to process the first label associated with the first object by:
determining whether the one or more identifiers are indicative of a barcode;
responsive to determining the one or more identifiers are indicative of a barcode, decoding the one or more identifiers; and
selecting a decoded identifier corresponding to a predetermined symbology and/or barcode data structure.

26. The non-transitory computer-readable medium of claim 21, wherein the instructions, when executed, cause the one or more processors to process the first label associated with the first object by:
determining whether the one or more identifiers are indicative of a barcode;
responsive to determining the one or more identifiers are not indicative of a barcode, utilizing character recognition to recognize the one or more identifiers; and
selecting a recognized identifier corresponding to a predetermined character string structure.

27. The non-transitory computer-readable medium of claim 21, wherein the instructions, when executed, further cause the one or more processors to:
generate a record of the determined location of the first label; and
modify an entry of a log associated with the area based on the determined location of the first label, the log being indicative of an inventory of the one or more objects within the area.

28. A method, comprising:
deriving a location and orientation of a device during capture of an image of one or more objects present in an area based on information of the area and data of at least one sensor of the device, the information being indicative of a type of the area and a map of the area;
detecting a first label associated with a first object, the first label having one or more identifiers;
processing the first label associated with the first object;
determining a location of the first label associated with the first object within the area based on the derived location and orientation of the device; and
assigning the first label an indicator denoting the determined location of the first label and that the first label has been processed.
